(19) United States
(12) Patent Application Publication
(10) Pub. No.: US 2017/0187575 A1
(43) Pub. Date: Jun. 29, 2017

(54) System and method for customizing standard device-orientated services within a high scale deployment

(71) Applicant: CA, Inc., New York, NY (US)

(72) Inventor: Daniel Richard Waugh, Chapel Hill, NC (US)

(73) Assignee: CA, Inc.

(21) Appl. No.: 14/998,234

(22) Filed: Dec. 24, 2015

(51) Int. Cl. H04L 12/24; H04L 12/26

(52) U.S. Cl. CPC H04L 41/0806; H04L 43/0876

(57) ABSTRACT

According to an aspect of the present disclosure, a method is provided that monitors networking devices based on first set of key performance indicators (KPI), which are based on a first service agreement. The method also includes receiving a second configuration template defining a second set of KPIs for monitoring the network devices. The second set of KPIs is different from the first set of KPIs. While continuing to monitor first set of KPIs, the method further includes generating a second configuration file. While continuing to monitor the first set of KPIs, the method also includes re-configuring a monitoring circuit to monitor the second set of KPIs in accordance with the second configuration file. Subsequent to reconfiguring the monitoring circuit to monitor the second set of KPIs, the method includes monitoring the second set of KPIs in accordance with the second configuration.

### TECHNICAL FIELD

The present disclosure relates to management of device-oriented services, and more particularly, to systems and methods for customizing standard device-orientated services within a high scale deployment.

### BACKGROUND

Major communication service providers (CSP) deploy hundreds of thousands of network devices at customer sites around the world. The CSPs need the ability to comprehensively monitor and report on these network devices. The monitoring and reporting function may be performed by an operator or an outsourced entity that deploys the systems and applications that perform the monitoring of the network devices. A standardized monitoring solution may be desired by the operator for reasons related to cost containment, ease of operator training, and inter-operable applications (e.g., standardized application programmatic interfaces (APIs)). However, because of the large number of network devices in a high scale deployment, achieving a standardized monitoring solution may be particularly difficult while still providing relevant information for each CSP or customization for each networked device.

Achieving a standardized monitoring solution within a high scale deployment is at odds with the fact that all customers are not the same and will require non-standard customizations based on varying needs. Current monitoring solutions provided by the operators require a business decision on what Key Performance Indicators (KPIs) and network devices are to be monitored upon initial deployment of the monitoring solution. If there are any changes based, for example, on different networked device-types added or changes in a service level agreement (SLA) requested by a CSP with different KPIs, a re-deployment of the entire monitoring solution is required. The re-deployment of the monitoring solution creates gaps in monitoring coverage of the network device(s) as well as being a very large and expensive to re-deploy the monitoring solution for hundreds or thousands or millions of devices. A CSP (e.g., VERIZON™, SPRINT™, etc.) typically deploys hundreds of thousands of devices in a Software-as-a-Service (SaaS) or a multi-system operator (MSO) solution. The CSP's desire cost savings which, in turn, leads to a need for standardization of monitoring solutions. However, the standardization of monitoring solutions prevents the ability to customize or update the solutions to meet a CSP's or end-user individual needs without having to completely redeploy the monitoring solution.

### SUMMARY

According to one aspect of the present disclosure, a method is provided that is implemented in a monitoring node or computer in a communications network. The method includes receiving a first configuration template at a monitoring computer. The first configuration template defines a first set of key performance indicator (KPI) metrics for monitoring a network device based on a first service agreement. The first service agreement may be an agreement (e.g., a service level agreement) between a CSP and monitoring service operator. The method also includes generating a first configuration for monitoring the first set of KPIs from the first configuration template. The method also includes configuring a monitoring circuit to monitor the first set of KPIs based on the first configuration. The method further includes monitoring the first set of KPIs based on the first configuration. The method also includes receiving a second configuration template, where the second configuration template defines a second set of KPIs for monitoring the network device. The second configuration template is different from the first set of KPIs. While continuing to monitor the first set of KPIs and responsive to receiving the second configuration template, the method further includes generating a second configuration from the second configuration template. While continuing to monitor the first set of KPIs, the method also includes re-configuring the monitoring circuit to monitor the second set of KPIs in accordance with the second configuration. Subsequent to reconfiguring the monitoring circuit to monitor the second set of KPIs, the method includes monitoring the second set of KPIs in accordance with the second configuration.

According to another aspect of the present disclosure, a monitoring device in a communications network includes a communications interface circuit. The communications interface circuit is configured to receive a first configuration template defining a first set of KPI metrics for monitoring a network device in accordance with a first service agreement. The communications interface circuit is also configured to receive a second configuration template defining a second set of KPIs for monitoring the network device, wherein the second set of KPIs are different from the first set of KPIs. The monitoring device also includes a processing circuit. The processing circuit is configured to generate a first configuration for monitoring the first set of KPIs from the first configuration template. The processing circuit is also configured to configure the monitoring device to monitor the first set of KPIs in accordance with the first configuration. The processing circuit is also configured to monitor the first set of KPIs in accordance with the first configuration. While monitoring the first set of KPIs, the processing circuit is configured to generate, responsive to receiving the second configuration template, a second configuration for monitoring the network device from the second configuration template. While still monitoring the first set of KPIs, the processing circuit is configured to re-configure the monitoring device to monitor the second set of KPIs in accordance with the second configuration. The processing circuit, subsequent to re-configuring the monitoring device to monitor the second set of KPIs, is also configured to monitor the second set of KPIs in accordance with the second configuration.

According to another aspect of the present disclosure, a method includes, at a provisioning device in a communications network, generating a first configuration template defining a first set of key performance indicator (KPI) metrics for monitoring a network device in accordance with a first service agreement. At the provisioning device, the method also includes sending the first configuration template to a monitoring device via the communications network. In response to receiving the first configuration template, the method includes the monitoring device generating a first configuration for monitoring the first set of KPIs from the first configuration template. The method also includes, at the monitoring device, configuring a monitoring circuit to monitor the first set of KPIs in accordance with the first configuration. The method also includes, at the monitoring device, monitoring the first set of KPIs in accordance with the first configuration. At the provisioning device, generating a second configuration template defining a second set of key performance indicator (KPI) metrics for monitoring the network device, wherein the second set of KPIs is different from the first set of KPIs. At the provisioning device, the method includes sending the second configuration template to the monitoring device via the communications network. The method further includes, at the monitoring device, while monitoring the first set of KPIs, generating a second configuration for monitoring the second set of KPIs from the second configuration template. While still monitoring the first set of KPIs, the method further includes re-configuring the monitoring circuit to monitor the second set of KPIs in accordance with the second configuration. Subsequent to re-configuring the monitoring circuit, the method includes monitoring the second set of KPIs in accordance with the second configuration.

Of course, the present disclosure is not limited to the above features and advantages. Indeed, those skilled in the art will recognize additional features and advantages upon reading the following detailed description, and upon viewing the accompanying drawings.

### BRIEF DESCRIPTION OF THE DRAWINGS

Aspects of the present disclosure are illustrated by way of example and are not limited by the accompanying figures with like references indicating like elements.

FIG. 1 is a block diagram illustrating some components of a communications network configured according to one embodiment of the present disclosure.

FIG. 2 is a block diagram illustrating the communication of KPIs from the provisioning computer to the monitoring computer, including the monitoring of the network devices by the monitoring computer according to one embodiment of the present disclosure.

FIG. 3 is table illustrating types of KPIs, monitoring conditions, and resulting messages according to one embodiment of the present disclosure.

FIGS. 4A-4B are combined data flow and timing diagrams illustrating the flow of information within the communications network according to one embodiment of the present disclosure.

FIG. 5 is a block diagram illustrating some components of a provisioning computer configured according to one embodiment of the present disclosure.

FIG. 6A is a block diagram illustrating some components of a monitoring computer configured according to one embodiment of the present disclosure.

FIG. 6B is a block diagram illustrating a view of a processing circuit of the monitoring computer configured according to one embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely as hardware, entirely as software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a non-transitory computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

Embodiments of the present disclosure provide a method, a system, a provisioning node, and a monitoring node for facilitating the ability of a communication service provider (CSP) (e.g., VERIZON™, SPRINT™, etc.), and/or a customer of the CSP, to comprehensively monitor the health and performance of one or more network devices used to provide communication services to their customers. Generally, the CSPs enter into a service level agreement (SLA) with their customers prior to the initial deployment of the network devices. The SLA defines a “monitoring solution” that identifies the particular network devices and metrics (i.e., the KPIs) that the customer, and/or the CSP, will monitor.

With conventional systems, whenever network devices are changed (e.g., a device is added to or removed from the network, or the KPIs for one or more existing devices change or are updated), the CSP and the customer re-negotiate the existing SLA. Since the monitoring parameters have changed, conventional processes require the re-deployment of the entire monitoring solution defined by the re-negotiated SLA. Not only is this process costly and time-consuming, but it also requires the current monitoring solution to be stopped while the network device monitoring parameters are configured according to the re-negotiated monitoring solution. Additionally there are real-time considerations for the CSP. Hundreds of devices a day are continually being added and deleted to the monitoring systems. The rate is such that monitoring configuration changes cannot be made without negatively affecting the rate of change. Further, CSPs often desire to deploy devices before the full extent of required monitoring is known. Conventional systems are not able to support such deployment. Thus, conventional methods can cause gaps in monitoring coverage.

Embodiments of the present disclosure, therefore, allow the CSPs, as well as their customers, to alter and re-deploy monitoring solutions without having to cease monitoring the devices according to a current monitoring solution. Particularly, according to some embodiments, customers interact with a provisioning computer provided by the CSP to define and re-define their monitoring solutions (i.e., their network devices and the KPIs to monitor). Once defined, the provisioning computer communicates the information to a monitoring computer that is operatively connected to the network devices. The monitoring computer, in turn, then generates a configuration file from the received information, and uses it to configure/re-configure itself to monitor the network devices according to the updated or new configuration. Notably, such reconfiguration occurs while the monitoring computer continues to monitor the network devices in accordance with a previously monitoring solution. Once the devices are reconfigured, the monitoring computer will monitor the network devices and KPIs as defined by the new monitoring solution.

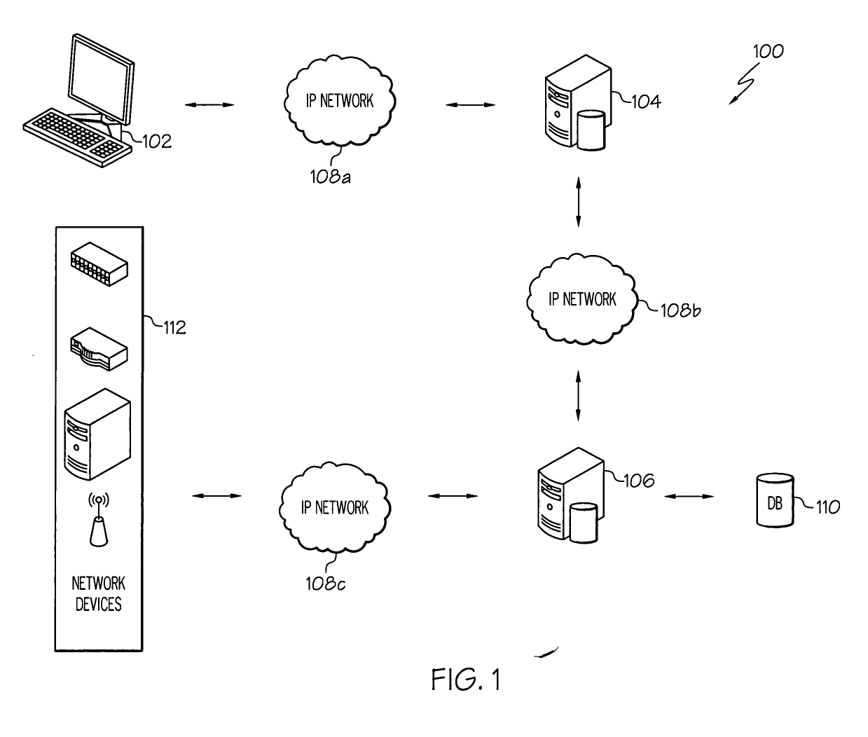

Referring now to the drawings, FIG. 1 is a block diagram illustrating some components of a communications system 100 configured according to one embodiment of the present disclosure. As those of ordinary skill in the art will readily appreciate, the components of communications system 100 seen in FIG. 1 are for illustrative purposes only. Thus, communications systems 100 suitable for configuration according to the present embodiments may comprise more or fewer components, or in some cases, components that are different than those illustrated in FIG. 1.

Communications system 100 comprises one or more communication networks 108a, 108b, 108c (collectively, networks 108) communicatively connecting an end-user computer 102 or terminal, a provisioning computer 104, and a monitoring computer 106. Additionally, monitoring computer 106 may be operatively connected to a mass storage device (DB) 110. As described in more detail below, CSPs and their customers can utilize communications system 100 to monitor the health and performance of one or more network devices 112 according to the present disclosure.

Networks 108, which may be the same network or different networks, may comprise one or more public and/or private wireless and/or wired communications networks. To that end, each of the networks 108 may be configured to communicate data using any protocol known in the art, but in some embodiments, communicate data between the entities in FIG. 1 using one or more well-known protocols such as TCP/IP, 802.xx, WiFi, and the like.

The end-user computer 102 is a computing device associated with a customer of the CSP. Generally, these customers interact with the provisioning computer 104 via computer 102 to define the specifics of their monitoring solutions, and from time-to-time, subsequently alter those specifics. For example, a customer may utilize computer 102 to log onto the provisioning computer 104 using any method known in the art. Once logged on, the provisioning computer 104 may provide computer 102 with a graphical user interface (GUI), or other such interface, with which the customer can select the particular network devices 112 to monitor, and/or the particular KPIs to monitor on each of the selected devices 112. By way of example only, the customer may utilize the provided interface to add, update, or delete one or more network devices 112, and/or define which particular KPIs should be monitored for each device 112. Additionally, the CSP can perform these functions in addition to, or on behalf of, the customer.

Once the provisioning computer 104 receives the information, provisioning computer 104 generates a configuration template based on that information. As seen in more detail later, the configuration template provides the monitoring computer 106 with the selected network devices 112 and KPIs, as well as other information as needed or desired. The monitoring computer 106 then utilizes the information in the configuration template to generate a corresponding configuration file that configures the monitoring computer to monitor the new and/or updated network devices 112. The configuration file may specify, for example, the time intervals for a network device 112 to report certain metrics data (e.g., every 5 minutes), and/or the particular data to report to the monitoring computer 106. Alternatively, or additionally, the configuration file may configure a network device 112 to store certain information regarding its operation, and then report the stored information to the monitoring computer 106 (and/or some other computing device) upon detecting an occurrence of some predetermined event. Still other embodiments may configure the monitoring computer to actively control the network devices to provide such information utilizing, for example, a request/response mechanism.

Monitoring computer 106 may be operatively coupled to a mass storage device, such as DB 110, hosting a database (e.g., DB2™, ORACLE™, and the like) for storing and organizing the information (e.g., KPIs, configuration templates, networked device communication templates and/or communication protocols used for communication with the networked devices 112, etc.) according to the present embodiments. As seen in FIG. 1, DB 110 comprises a storage device that is separate from the monitoring computer 106. However, those of ordinary skill in the art will readily appreciate that DB 110 may be included with the monitoring computer 106.

The networked devices 112 include, but are not limited to, various devices such as routers, switches, modems, access points, communication devices (e.g., phones, tablets), servers and/or applications running on those servers, and the like. As stated above, these devices may be selectively configured for monitoring by the monitoring computer 106 in accordance with the generated configuration files. Conventionally, the monitoring of these devices 112 is temporarily stopped while they are re-configured according to a new configuration defined in the configuration templates by the CSP operator. However, in accordance with the present embodiments, the monitoring computer 106 can reconfigure the network devices 112 according to configuration information received with a new and/or updated configuration template without ceasing to monitor the network devices 112 according to a previous configuration. Further, the present embodiments maintain historical data at all times. Thus, with reconfiguration, the present embodiments will begin maintaining historical data for metrics that are newly added to the configuration information. Similarly, the present embodiments will cease maintaining historical data for metrics that have been deleted from the configuration information.

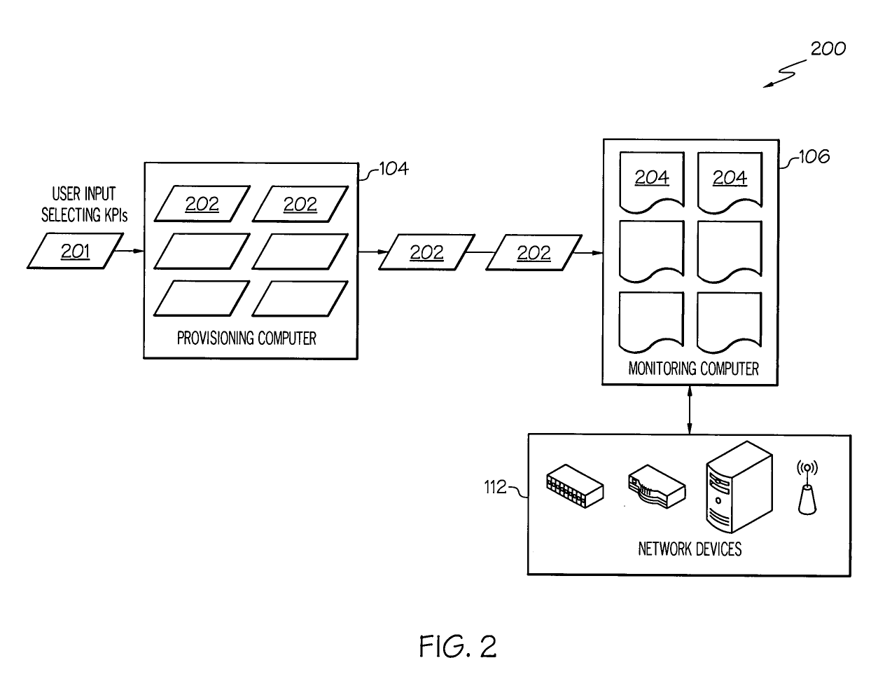

FIG. 2 is a block diagram 200 illustrating the generation and communication of configuration template 202 from the provisioning computer 104 to the monitoring computer 106, and the subsequent generation of the configuration files 204 from the configuration templates 202 at the monitoring computer 106.

Particularly, the provisioning computer 104 receives a set of KPIs 201 from computer 102. As will be described in more detail later, the KPIs 201 may define various performance metrics (e.g., CPU utilization, response times, and the like) associated with aspects of the network devices 112 to be monitored, as well as the identities of one or more specific network devices 112 to monitor. The set of KPIs 201 may be defined based in a network service agreement or service level agreement (SLA) between the customer and the CSP.

Upon receipt of the information, the provisioning computer 104 generates a configuration template 202. The configuration template 202 is device-specific and defines the set of KPI 201 metrics for monitoring the network device(s) 112 in accordance with the network service agreement or SLA. In addition, the configuration template 202 may also include other information, such as information identifying a customer associated with the service agreement, the particular services that are to be monitored for that customer, network device types, network device identification, a set of instructions for monitoring a given device, and the like. For example, a customer may sign a service agreement with the CSP operator to monitor various hardware utilization parameters of their network device(s) 112 (e.g., CPU and memory). Thus, the set of KPIs 201 and instructions associated with monitoring and reporting those parameters would be included in the configuration template 202 that is generated by the provisioning computer 104. Once generated, the provisioning computer 104 sends the configuration template 202 to the monitoring computer 106 via the communications network 108.

Responsive to receiving the configuration templates 202, the monitoring computer 106 generates one or more corresponding configuration files 204 to be used for monitoring the set of KPIs 201 identified in the configuration template 202. For example, in one embodiment, the monitoring computer 106 makes a copy of the configuration template 202 and saves this copy as a device-specific configuration file 204. In another embodiment, however, the monitoring computer 106 creates a device-specific configuration file 204 from the information in the configuration template 202. By way of example, information may be extracted from the configuration template 202, processed and/or manipulated, and then used to build the configuration file 204. Regardless of the particular method for generating the configuration files 204, however, the generated configuration files 204 may be stored in DB 110, or in some other storage or memory accessible to monitoring computer 106. As stated above, the configuration files 204 are then used to configure the network devices 112 and/or the monitoring computer for monitoring.

Monitoring the networked devices 112 may continue indefinitely or as otherwise desired. For example, the monitoring computer 106 may monitor the network devices 112 for a period of days or a portion of each day or days. The information indicating such monitoring periods may be defined, as stated above, in the set of KPIs 201 received from the computer device 102. Alternatively or additionally, however, monitoring periods may be defined in a set of default configuration information used by provisioning computer 104 when generating the configuration files 204. Thus, the customer that contracted with the CSP operator to monitor their network devices 112 can set their own monitoring periods, use whatever default monitoring periods may be defined by the CSP operator in the default configuration template, or both.

Further, as will be described later in more detail, embodiments of the present disclosure allow the customer and/or the CSP operator to dynamically change the monitoring periods for one or more of the network devices 112, as well as the particular network devices 112 and the KPIs 201 to monitor on those network devices 112, without having to re-negotiate the existing service agreement. This is particularly beneficial as any reconfiguration of the network devices 112 that may needed due to the newly defined monitoring periods and/or altered KPIs may be accomplished while the monitoring computer 106 continues to monitor the network devices 112.

For example, after initially configuring the network devices 112 in accordance with the KPI information embodied in a first configuration template, the monitoring computer 106 may subsequently receive one or more additional configuration templates 202. Each additional configuration template 202 may define an updated or additional set of KPIs 201 for monitoring the network device(s) 112, for example, and/or identify one or more network devices 112. Such may occur, for instance, when a new network device 112 is added or removed. Regardless, while the monitoring computer 106 is monitoring the networked device(s) 112 based on the first configuration template 202, the monitoring computer 106 may generate one or more additional configuration files 204 based on the additional configuration templates 202, and then subsequently re-configure its circuitry to monitor the networked device(s) 112 in accordance with the additional configuration files 206.

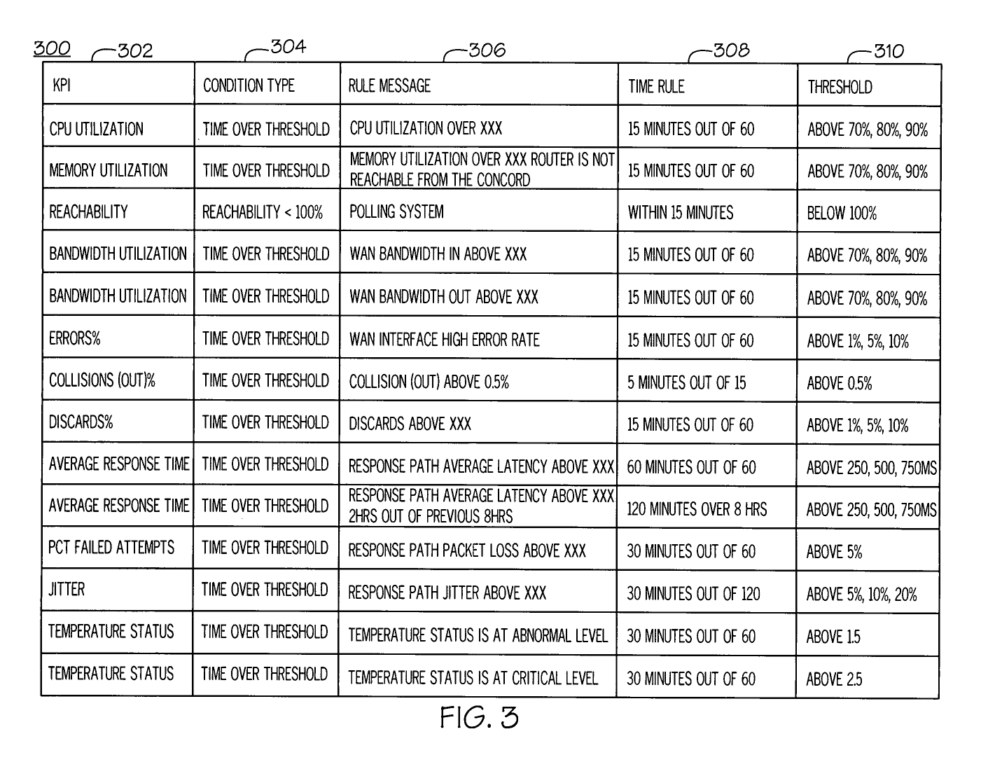

FIG. 3 is a table 300 illustrating some of the information that may be defined by a user (e.g., the customer or CSP) at computing device 102, and sent to the provisioning computer 104 for use in generating the configuration templates 202. Those of ordinary skill in the art will appreciate that the information identified in table 300 is for illustrative purposes only, and that table 300 may define additional and/or alternate information as needed or desired.

As seen in FIG. 3, table 300 comprises a KPI column 302, a Condition Type column 304, a Rule Message column 306, a Time Rule column 308, and a Threshold column 310. This information may be provided by the provisioning computer 104, for example, by way of a Graphical User Interface (GUI) that is displayed to the user of computer device 102. The KPI column 302 identifies the various KPIs (i.e., parameters) that may be monitored for a particular network device 112. As non-limiting examples, the various types of KPIs that may be monitored may include CPU Utilization, Memory Utilization, Reachability, Bandwidth, Response time, Collisions, Temperature information, and the like. The various types of KPIs may also include any metric or parameter that may otherwise be an attribute describing a hardware or software aspect of the networked devices 112.

The Condition Type column 304 defines a condition type(s) for each KPI identified in KPI column 302. This information identifies the particular condition that is monitored for by the monitoring computer 106. By way of example only, the Condition Type column 304 defines the condition for the “Reachability” KPI as being “Reachability<100%.” Thus, the “Reachability” KPI is intended to identify the amount of time that a given network device 112 cannot be communicated with (i.e., is not “reachable”). In another example, the condition defined in the Condition Type column 304 for the “CPU Utilization” KPI is “Time over Threshold.” Thus, the CPU Utilization KPI, in this instance, is intended to monitor a condition in which the CPU of a given network device 112 remains above a given threshold value. Other types of conditions that may be defined in the Condition Type column 304 include, but are not limited to, a Time Over/Under condition (e.g., the amount of time a KPI value for a given network device 112 is above/under a specified threshold value), “Equal to or Within a Defined Threshold or Range” condition (e.g., the amount of time a KPI value for a given network device 112 is equal to or within a specified range of values), a “Percentage of Up-time/Down-time” condition (e.g., the amount of time a given network device 112 is operational/non-operational), and a “Percentage of Time the Device has been Reachable.”

The Rule Message column 306 defines a message that is output to a log file, for example, whenever the condition type for the particular KPI associated with the Rule Message is detected. The message may be selected from a list of predefined messages, for example, or may be custom-defined by a user, and may be defined based on any combination of KPIs and conditions defined in KPI column 302 and Condition Type column 304.

As an example, if the CPU utilization of a networked device 112 is being monitored it may be desired to determine a situation where the CPUs utilization is too high or too low for an extended period of time. A CPU utilization that is too high for too long of a time period may indicate a loading problem for the networked device 112 being monitored. A low CPU utilization may indicate a problem with another device that is connected to the monitored network device 112 (e.g., an upstream switch or node), or may simply indicate that the network device 112 is under-utilized. With this latter scenario, the networked device 112 may be a candidate to have networking traffic loads re-routed through the networked device 112 without impacting other network traffic. Those of ordinary skill in the art will realize that it is not necessary that any action be taken in response to the condition based on the message. Instead, the condition may be simply logged and recorded in memory or storage.

The Time Rule column 308 defines time information related to the condition identified in the Condition Type column 304, while the “Threshold” column 310 defines the particular threshold value for the rule information. The values for both the Time Rule column 308 and the Threshold column 310 are relative to the particular KPI defined in the KPI column 302. As an example, the time information in the Time Rule column 308 may define a predetermined time threshold, such as “15 minutes out of 60 minutes,” that is associated with the “CPU Utilization” KPI and the “Time over Threshold” condition. Similarly, the corresponding threshold value in the “Threshold” column 310 defines the particular thresholds (e.g., 70%, 80%, 90%). Thus, in this example, the time information indicates that any CPU utilization for a given network device 112 exceeding one of the pre-defined threshold values (i.e., 70%, 80%, 90%) for a cumulative time period of 15 minutes out of a 60 minute window is to be logged. The corresponding log message may be, for example, “CPU Utilization Over 70%-23 minutes” in accordance with the corresponding message in the Rule Message column 306, and therefore, convey an indication of problem severity based on the degree to which the threshold value in the Threshold column 310 is exceeded.

In another example, the rule information in the Rule Parameter column 308 may define a pre-determined contiguous block of time (e.g., “in excess of 15 minutes”) associated with such CPU utilization (or some other KPI). In such cases, whatever message is defined in the corresponding Rule Message column 306 could be logged if the CPU Utilization exceeds the defined values in the Threshold column 310 (e.g., 70%, 80%, 90%). As those of ordinary skill in the art will readily appreciate, other conditions, rules, messages, and thresholds may be defined as needed or desired.

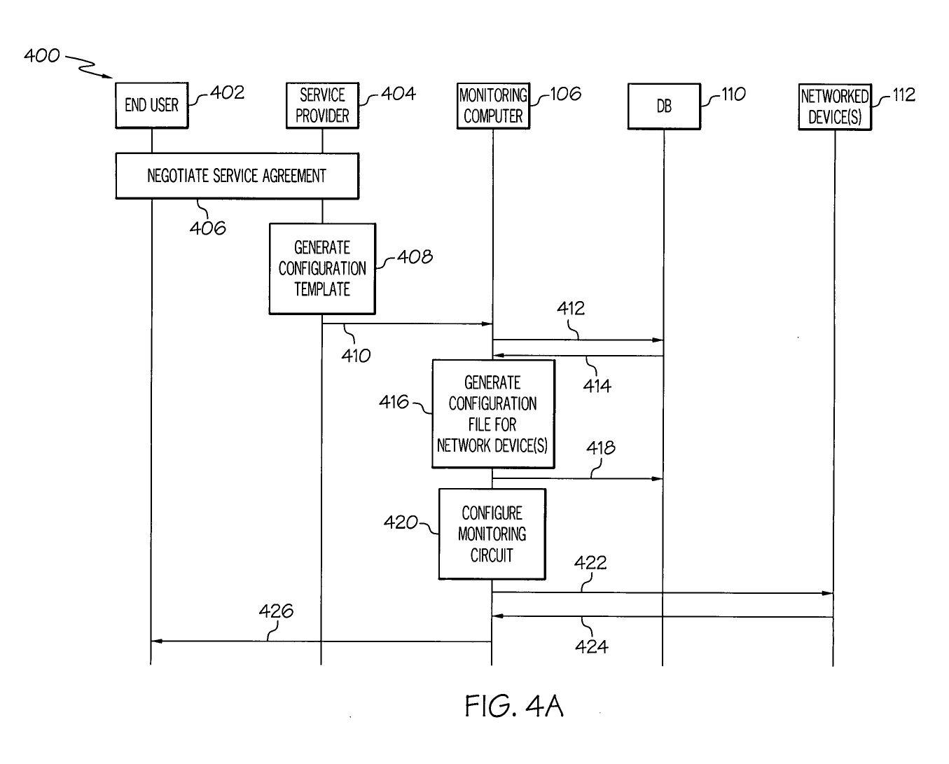

FIGS. 4A-4B are data flow and timing diagrams 400 illustrating the flow of information within the communications network 100 according to one embodiment of the present disclosure. As seen in FIG. 4A, the end-user 402 (e.g., a customer that wishes to monitor their network devices 112) negotiates the terms of a service agreement (box 406) with a service provider 404 (e.g., a CSP operator). The negotiated service agreement represents a set of defined KPIs 201 for monitoring the end-user's 402 network devices 112. As previously described, the end-user 402 may use the provisioning computer 104 via an interactive user interface (e.g., a GUI—not shown) to enter, select, or otherwise identify a set of KPIs 201 in accordance with the negotiated service agreement. Additionally, or alternatively, the KPIs 201 may be provided to the provisioning computer 104 via bulk file uploads or selecting predefined and/or standardized configuration templates 202 stored in the database 110.

In some instances, the end-user 402 may not have access to the provisioning computer 104. Thus, the provisioning computer 104 may be operated by the service provider 404 such that the KPIs 201 may be entered, selected, or otherwise provided by the service provider 404. It should be understood that the provisioning computer 104 and the monitoring computer 106 may be the same computing device, or they may be different computing devices. Regardless, however, the provisioning computer 104 comprises the circuitry configured to generate the configuration template 202 (box 408).

Once generated, the provisioning computer 104 sends the configuration template 202 to the monitoring computer 106 (line 410). For example, the provisioning computer 104 may transmit the configuration templates 202 to the monitoring computer 106 via network 108 (e.g., network 108c), or save the generated configuration template 202 to a predefined storage location in a shared storage device or DB 110. Once received (or retrieved), the monitoring computer 106 may store 412 the configuration template 202 to DB 110 (line 412), so that the information is thereafter available to be retrieved by monitoring computer 106 (line 414) should that data be required. Thus, DB 110 may comprise a KPI repository.

Regardless of how the configuration template 202 is received at the monitoring computer 106, the monitoring computer 106 generates a configuration file 204 based on the information in the configuration template 202 (box 416). The generated configuration file 204 may then be stored in DB 110 and associated with the configuration template 202 that was used in its generation (line 418). Storing the configuration file 204 and/or the configuration template 202 in the DB 110 allows for their future use as a default configuration template 202, for example, that may or may not be customized and used to monitor future configurations of networked device(s) 112.

Using the configuration file 206, the monitoring computer 106 configures its monitoring circuit to monitor the KPIs and networked devices 112. By way of example only, the monitoring device 106 may configure its monitoring circuit to poll the network devices 112 for the specified KPIs, or transmit requests for the information (line 422) directly to the networked devices 112. In these latter cases, the monitoring computer 106 may request certain parameter values stored at specific memory locations in the network device 112, or issue a command that causes the network device to retrieve the desired KPI information and return it in a response message to the monitoring computer 106 (line 424).

In some embodiments the monitoring device 106 may not directly request KPI data from the network devices 112, but rather, may simply send a signal to test the availability of or access to the networked devices 112. In such cases, “ping” signals may periodically be sent to the network device (line 422). As long as the monitoring device 106 receives an answer or “return ping,” (line 424), the monitoring device 106 may determine, for example, that the particular network device is “reachable.”

In other embodiments the monitoring computer 106 may transmit request messages to the networked devices 112 requesting that certain KPI data be provided by the networked devices 112 (line 422). In such cases, the request messages may be sent based on a determination by the monitoring computer 106 of whether a KPI condition exists. If the KPI condition exists, or if a certain KPI status is met, the monitoring computer 106 receives the information (line 424), and then may subsequently report or transmit the received information to the end-user 402 (line 426). Alternatively, or additionally, the KPI information returned by the network devices 112 may be reported or transmitted to the service provider 404, or stored in the DB 110 for later retrieval.

As previously stated, the present embodiments allow for changes to be made to the particular KPIs and other metrics to be monitored without having to cease on-going monitoring operations, as was conventional. FIG. 4B illustrates one such embodiment as a continuation of method 400 in FIG. 4A. More particularly, FIG. 4B illustrates a situation where the KPIs for the network devices 112 currently being monitored by the monitoring computer 106 will be updated or replaced with a subsequent configuration based on an updated set of KPIs 201.

As seen in FIG. 4B, the end-user 402, and/or the service provider 404, may provide an updated, or different, set of KPIs 201 to the provisioning computer 104 (line 428). Upon receipt, the provisioning computer 104 then generates an additional or updated configuration template 202 based on the provided information (box 430). The provisioning computer 104 then transmits the additional or updated configuration template 202 to the monitoring computer 106 (line 432) via the network 108, or via a shared storage device or DB 110, as previously described.

The monitoring computer 106 may then store the updated or additional configuration template 202 in memory or DB. 110 (line 434) for later retrieval (box 436) and/or for use in generating other default configurations for network devices 112, as previously described. However, based on the updated configuration template 202, the monitoring computer 106 may update an existing configuration file 204 to reflect the changed information, and/or generate an updated configuration file 204 (box 438), and then stores the configuration in file 206 in the DB 110 as needed or desired (line 440).

The monitoring computer 106 then configures its monitoring circuit (box 442) according to the updated configuration file 206, as previously described, to monitor the networked devices 112 (lines 444, 446). As above, such monitoring may be performed by polling the network devices 112 and interpreting the returned signals, transmitting requests to the networked devices 112 and receiving corresponding responses, testing the availability of, or access to, the networked devices 112, requesting specified KPI-related data to be provided by the networked devices 112, and the like. It should be noted that the determination to perform the monitoring functions may be made by the monitoring computer 106 based on whether a given condition exists. As above, those conditions may be specified by the end-user 202, and/or the service provider 404, and subsequently provided in the configuration template 202 to the monitoring computer 106. Based on a given KPI condition or status, the monitoring computer 106 may then subsequently report or transmit the updated KPI values to the end-user or service provider (line 448).

It should be noted that the updated configuration templates 202 and their associated generated configuration files 204 may be used to update the monitoring device 106 while the monitoring device 106 continues to monitor the network devices 112 based on the initial or previous configuration files 206. That is, the monitoring computer 106 need not cease monitoring operations whenever the end-user alters the KPI metrics, nor does it require re-booting or re-starting. This may be beneficial, for example, whenever an end-user 402 adds a network device to be monitored, removes or replaces an existing network device, or simply wishes to alter the particular KPIs that are being monitored of a given device. This differs from conventional monitoring systems, which require the end-user 402 and the service provider 404 to first negotiate a new service agreement. Once negotiated, the service provider 404 would then have to cease current monitoring operations to reconfigure the network devices 112 affected by the newly executed service agreement. Thus, the embodiments of the present disclosure eliminate gaps in monitoring coverage of the network devices 112, and also decrease the costs associated with deploying dynamically changing monitoring solutions.

In addition, the present embodiments allow for situations where neither the end-user 402 nor the service provider 404 have a set of known KPIs or device configuration parameters that may be monitored in connection with a particular network device 112, as well as for cases where multiple network devices 112 share a common configuration generated from a common set of KPIs (e.g., one device is being replaced by a same but updated device. To address such situations, one embodiment of the present disclosure configures the provisioning computer 104 to generate a default configuration template 202 comprising a default set of KPIs and device configuration parameters. Such information may be generated, for example, based on information available to the provisioning computer 104 such as the service provider identity, the end-user identity, a network type, service level, network device type and identity, and the like.

For example, some or all of this information may be mapped to a pre-defined set of KPIs that are known to be available for monitoring. In these cases, the provisioning computer 104 need only to retrieve these KPIs and/or related information to generate a default configuration template 202 based on that retrieved data. As another example, the provisioning computer 104 may be configured to identify one or more pre-existing configuration templates 202 that already define a set of KPIs based on the information. In these cases, the provisioning computer 104 may search for existing configuration templates 202 that define a set of KPIs that is the same or similar to those that would be associated with the retrieved information, and utilize the pre-existing configuration template 202 as a model for a new configuration template 202. That is, the provisioning computer 104 may create a duplicate copy of an existing configuration template 202, and modify the duplicate template as needed to reflect the more specific set of KPIs needed for monitoring the network device 112. Regardless, the provisioning computer 104 may transmit the updated configuration template 202 to the monitoring computer 106 to generate the corresponding configuration files 204 and begin monitoring the network devices 112 in a real-time update without operator intervention.

In other embodiments, the configuration templates 202 may be generated at the provisioning computer 104 based on one or more generic policies according to customer name, service level, network type and/or entity type. For example, the network type may be a MSO/managed network, a PIP/unmanaged network, an internet (wide area), an Ethernet (local), or the like. A policy may be associated with each of these network types identifying the set of KPIs and other information for each network. Upon identifying the particular type of network, the provisioning computer 104 could simply generate a configuration template 202 based on the information defined in the policy that corresponds to the identified network.

In addition, the provisioning computer 104 may be configured to generate a configuration template 202 based on other additional policies. By way of example, an MSO/managed network type may include cable service operators where a network device 112 (e.g., a set-top box) is generally managed remotely. Other possible network devices 112 in the network may include, but are not limited to, switches, routers, WAN accelerators, firewalls, vending machines, air conditioners, etc. In these cases, there may be a policy that is defined for the MSO/managed network type, as well as a policy defined for the set-top box. Each policy could define a set of KPIs to be monitored. According to the present disclosure, the provisioning computer 104 may generate a configuration file 202 based on the information defined in both policies to ensure monitoring coverage for a default set of KPIs at a default set of network devices 112. An end-user 402 and/or a service provider 404 can then edit the generated configuration template 202 to update the configurations for one or more of the network devices 112 as needed or desired.

There may be situations in which configuration information does not exist for a given network device 112, or is not readily available. In these cases, the configuration template 202 that is generated by provisioning computer 104 may comprise a default configuration template. Such default configuration templates may comprise a default or generic set of KPIs to be monitored that are pre-defined by the end-user 402, the service provider 404, or both, and may be based at least partially on the functional capabilities of the network device 112 and/or network 108.

It should be noted that the monitoring computer 106 may continue to monitor a given network device 112 according to a first configuration file 204 generated from a first configuration template 202, while also monitoring the network device 112 according to a second configuration file 204 generated from a first configuration template 202. Thus, multiple configurations may be used by the monitoring computer 106 simultaneously to monitor one or more network devices 112. Additionally, the information in any of those existing configurations (e.g., the set of KPIs) may be replaced or updated without having to re-boot or re-start the monitoring computer 106. Monitoring according to added, updated or deleted configurations files 206 may occur upon storage of the particular configuration file 204 in the database 110 or memory circuit.

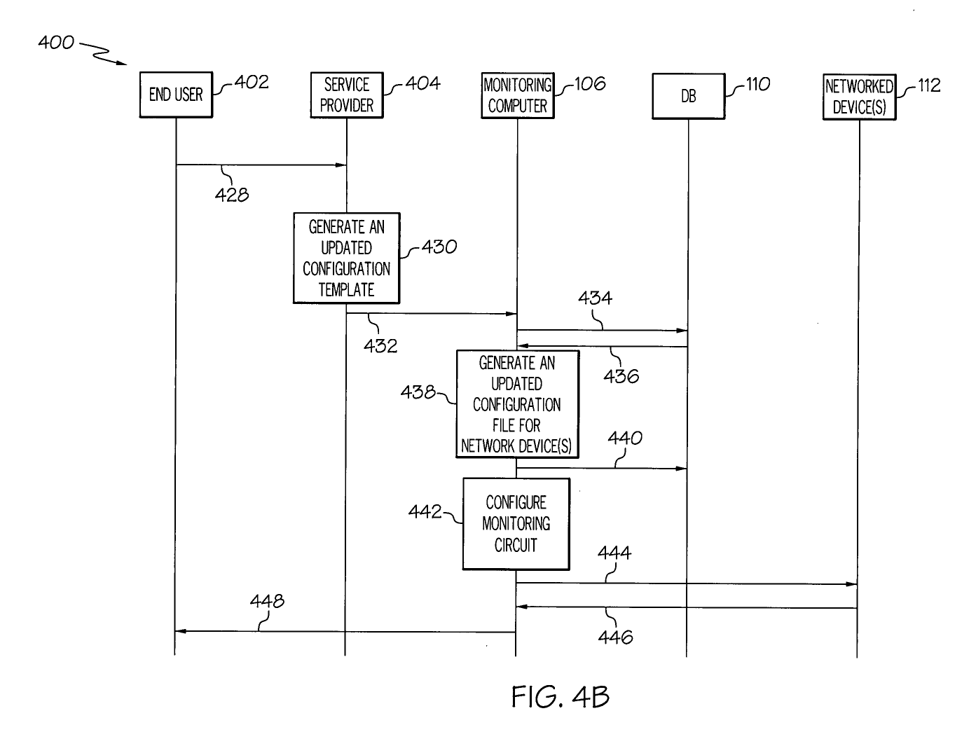

FIG. 5 is a block diagram illustrating some components of a provisioning computer 104 configured according to one embodiment of the present disclosure. The provisioning computer 104 includes a communications interface circuit 502, a memory circuit 504, and a processing circuit 508. The communications interface circuit 502 may comprise, for example, an I/O card or other interface circuit configured to communicate data and information with the end-user computer device 102 and the monitoring computer 106 via one or more networks 108. In embodiments of the present disclosure, the communications interface circuit 504 is configured to receive information from the end-user computer 102 related to the monitoring of network devices 112 (e.g., the KPI information, etc.), as well as to send the configuration templates 202 it generates based on that received information to the monitoring computer 106.

As those of ordinary skill in the art will readily appreciate, the communications interface circuit 502 may communicate with these and other entities using any known protocol needed or desired. In one embodiment, however, communications interface circuit 502 sends data to and receives data from these entities in data packets according to the well-known ETHERNET protocol. In this regard, communications interface circuit 502 may comprise one or more ETHERNET cards, but may also comprise circuitry capable of wireless communications such as over WiFi, for example.

The memory circuit 504 may comprise any non-transitory, solid state memory or computer readable storage media known in the art. Suitable examples of such media include, but are not limited to, ROM, DRAM, Flash, or a device capable of reading computer-readable storage media, such as optical or magnetic storage media. Memory circuit 504 stores programs and instructions such as control application 514 that when executed by processing circuit 508, configures the provisioning computer 104 to perform the functions previously described. Such functions include, but are not limited to, generating one or more configuration templates 202, sending those templates 202 to the monitoring computer 106, and in some embodiments, providing a GUI with which an end-user 402 at computer device 102 can use to define a set of KPIs 201 and other monitoring-related information. In some embodiments, memory circuit 504 also stores the generated configuration templates 202.

Processing circuit 508 may be implemented by circuitry comprising one or more microprocessors, hardware, firmware, or a combination thereof. Generally, processing circuit 508 controls the operation and functions of the provisioning computer 104 according to appropriate standards to perform such functions as communicating data with the computer device 102 and monitoring compute 106. Additionally, according to various embodiments of the present disclosure, processing circuit 508 is configured to execute the control application 514 to perform the method of the present disclosure according to the embodiments previously described.

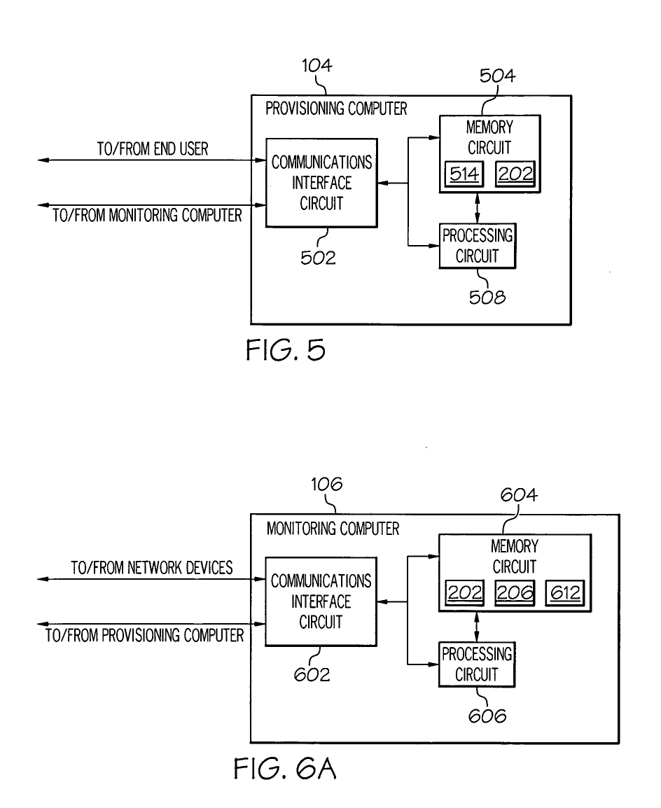

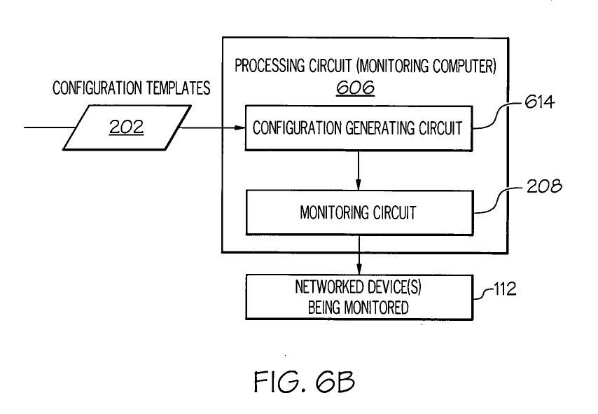

FIG. 6A is a block diagram illustrating some components of the monitoring computer 106 configured according to one embodiment of the present disclosure. The monitoring computer 106 may be similarly configured to the provisioning computer 104, and comprises a communications interface circuit 602, a memory circuit 604, and a processing circuit 606.

As above, communications interface circuit 602 may comprise one or more ETHERNET cards or other circuitry capable of wireless communications, but is generally configured to facilitate communications with the provisioning computer 104. Particularly, via the communications interface circuit 602, the monitoring computer 106 receives one or more configuration templates 202 from the provisioning computer 104, and sends information to the provisioning computer indicating the results of monitoring the network devices 112. In some cases, the monitoring computer 106 retrieves information from DB 110 via communications interface circuit 602.

The memory circuit 604, which comprises any non-transitory, solid state memory or computer readable storage media known in the art, may store the configuration templates 202 and/or configuration files 204 generated according to the present embodiments. Additionally, the memory circuit 604 stores a control application 612 that configures processing circuit 606 to perform the functionality previously described.

FIG. 6B is a functional block diagram illustrating a processing circuit 606 according to one embodiment of the present disclosure. As seen in FIG. 6B, processing circuit 606 comprises a configuration generating circuit 614 and a monitoring circuit 608, both of which comprise hardware circuitry configured to function in accordance with the instructions defined in the control application 612. The configuration generating circuit 614 For example, when executing the control application 612, the configuration generating circuit 614 generates configuration files 204 based on the configuration templates 202 received from the provisioning computer 104. The monitoring circuit 608 configures the monitoring computer 106 to monitor the network devices 112 according to those configuration files 206, and send reports of the monitoring results back to the provisioning computer 104, as previously described.

The present embodiments may, of course, be carried out in other ways than those specifically set forth herein without departing from essential characteristics of the disclosure. For example, it should be noted that the flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

Thus, the foregoing description and the accompanying drawings represent non-limiting examples of the methods and apparatus taught herein. As such, the present invention is not limited by the foregoing description and accompanying drawings. Instead, the present invention is limited only by the following claims and their legal equivalents.

What is claimed is:

1. A method implemented at a monitoring node in a communications network, the method comprising:
receiving a first configuration template, wherein the first configuration template defines a first set of key performance indicator (KPI) metrics for monitoring a network device in accordance with a first service agreement;
generating a first configuration for monitoring the first set of KPIs from the first configuration template;
configuring a monitoring circuit to monitor the first set of KPIs in accordance with the first configuration;
monitoring the first set of KPIs in accordance with the first configuration;
receiving a second configuration template, wherein the second configuration template defines a second set of KPIs for monitoring the network device that is different from the first set of KPIs; and
while continuing to monitor first set of KPIs:
generating, responsive to receiving the second configuration template, a second configuration from the second configuration template; and
re-configuring the monitoring circuit to monitor the second set of KPIs in accordance with the second configuration; and
monitoring the second set of KPIs in accordance with the second configuration.

2. The method of claim 1 wherein the second configuration template is defined in accordance with the first service agreement.

3. The method of claim 1 wherein the second configuration template is defined in accordance with a second service agreement that is different from the first service agreement.

4. The method of claim 1 wherein re-configuring the monitoring circuit to monitor the second set of KPIs in accordance with the second configuration comprises replacing the first configuration with the second configuration.

5. The method of claim 1 wherein re-configuring the monitoring circuit to monitor the second set of KPIs in accordance with the second configuration comprises updating the first configuration according to the second configuration.

6. The method of claim 1 wherein first set of KPIs comprises a KPI not comprised in the second set of KPIs.

7. The method of claim 1 wherein the second set of KPIs comprises a KPI not comprised in the first set of KPIs.

8. The method of claim 1 further comprising:
configuring the network device to indicate values corresponding to the first set of KPIs to the monitoring circuit; and
while continuing to monitor first set of KPIs, configuring the network device to indicate values corresponding to the second set of KPIs to the monitoring circuit.

9. The method of claim 1 wherein re-configuring the monitoring circuit to monitor the second set of KPIs in accordance with the second configuration comprises re-configuring the monitoring circuit to monitor a newly added network device.

10. The method of claim 1 wherein re-configuring the monitoring circuit to monitor the second set of KPIs in accordance with the second configuration comprises re-configuring the monitoring circuit to cease monitoring the network device.

11. A monitoring device in a communications network, the monitoring device comprising:
a communications interface circuit configured to:
receive a first configuration template defining a first set of key performance indicator (KPI) metrics for monitoring a network device in accordance with a first service agreement; and
receive a second configuration template defining a second set of KPIs for monitoring the network device, wherein the second set of KPIs is different from the first set of KPIs; and
a processing circuit configured to:
generate a first configuration for monitoring the first set of KPIs from the first configuration template;
configure the monitoring device to monitor the first set of KPIs in accordance with the first configuration;
monitor the first set of KPIs in accordance with the first configuration; and
while monitoring first set of KPIs:
generate, responsive to receiving the second configuration template, a second configuration for monitoring the network device from the second configuration template; and
re-configure the monitoring device to monitor the second set of KPIs in accordance with the second configuration; and
monitor the second set of KPIs in accordance with the second configuration.

12. The monitoring device of claim 11 wherein the processing circuit is further configured to replace the first configuration with the second configuration.

13. The monitoring device of claim 11 wherein the processing circuit is further configured to update the first configuration according to the second configuration.

14. The monitoring device of claim 11 wherein first set of KPIs comprises a KPI not comprised in the second set of KPIs.

15. The monitoring device of claim 11 wherein the second set of KPIs comprises a KPI not comprised in the first set of KPIs.

16. The monitoring device of claim 11 wherein the processing circuit is further configured to:
configure the network device to indicate values corresponding to the first set of KPIs to the monitoring circuit; and
while continuing to monitor first set of KPIs, configure the network device to indicate values corresponding to the second set of KPIs to the monitoring circuit.

17. The monitoring device of claim 11 wherein the processing circuit is further configured to re-configure the monitoring device to monitor a newly added network device.

18. The monitoring device of claim 11 wherein the processing circuit is further configured to re-configure the monitoring device to cease monitoring the network device.

19. A method comprising:
at a provisioning device in a communications network:
generating a first configuration template defining a first set of key performance indicator (KPI) metrics for monitoring a network device in accordance with a first service agreement;
sending the first configuration template to a monitoring device via the communications network;
at the monitoring device, responsive to receiving the first configuration template:
generating a first configuration for monitoring the first set of KPIs from the first configuration template;
configuring a monitoring circuit to monitor the first set of KPIs in accordance with the first configuration; and
monitoring the first set of KPIs in accordance with the first configuration;
at the provisioning device:
generating a second configuration template defining a second set of key performance indicator (KPI) metrics for monitoring the network device, wherein the second set of KPIs is different from the first set of KPIs;
sending the second configuration template to the monitoring device via the communications network;
at the monitoring device, while monitoring the first set of KPIs:
generating a second configuration for monitoring the second set of KPIs from the second configuration template;
re-configuring the monitoring circuit to monitor the second set of KPIs in accordance with the second configuration; and
monitoring the second set of KPIs in accordance with the second configuration.

20. The method of claim 19 wherein one or both of the first and the second configuration templates comprises a default set of KPIs for monitoring the network device that is generated by the provisioning device based on the first service agreement.

21. The method of claim 19 wherein one or both of the first and the second configuration templates comprises a user-selected KPI for monitoring the network device that is received by the provisioning device.

22. The method of claim 19 wherein the second set of KPIs comprises an updated KPI that is an updated version of a first KPI defined in the first configuration template, and wherein the second configuration template sent by the provisioning device controls the monitoring device to continue monitoring the network device according to the updated KPI.

23. The method of claim 19 wherein the second set of KPIs comprises a new KPI that is not defined in the first configuration template, and wherein the second configuration template sent by the provisioning device controls the monitoring device to begin monitoring the network device according to the new KPI.

24. The method of claim 19 wherein the second configuration template sent by the provisioning device controls the monitoring device to begin monitoring a newly added network device.

25. The method of claim 19 wherein the second configuration template sent by the provisioning device controls the monitoring device to cease monitoring the network device.
